(19) United States
(12) Patent Application Publication
(10) Pub. No.: US 2011/0264505 A1
(43) Pub. Date: Oct. 27, 2011

(54) METHOD AND SYSTEM TO ALLOW INDIVIDUAL SELLERS TO AUTOMATICALLY CLEARANCE ONE-OF-A-KIND LISTINGS

(75) Inventor: Suzanne M. Turner-Rielle, Midland, MI (US)

(73) Assignee: RIELLE LIFE LC, Midland, MI (US)

(21) Appl. No.: 13/093,108

(22) Filed: Apr. 25, 2011

Related U.S. Application Data
(60) Provisional application No. 61/328,277, filed on Apr. 27, 2010.

(51) Int. Cl. G06Q 30/00

(52) U.S. Cl. 705/14.39; 705/14.1

(57) ABSTRACT

A method and system for conducting electronic commerce that provides for an “auto-clearance” function in which, after expiration of a pre-determined listing period for an item for sale, the item is automatically placed on sale or “clearance” at a reduced price. The present invention allows an online seller of a unique, one-of-a-kind item to automatically place the item on clearance after a period of time.

### BACKGROUND OF THE INVENTION

1. Field of the Invention

This invention pertains in general to electronic commerce and in particular to a method and system for enabling sellers of one-of-a-kind items to automatically put the items on “clearance”.

2. Description of the Related Art

Most consumers are familiar with shopping at a physical retail store and the concept of a clearance sale. For example, if a retail store owner has merchandise that it wishes to clear from the store quickly, the retailer will drastically reduce the price of the merchandise in order to attract buyers to purchase the merchandise.

Today, consumers do not only shop at physical retail stores, but electronic commerce on the internet has also become commonplace. There are many merchants offering goods and services on web sites on the internet, and there are an even greater number of customers who purchase the goods and services. In many cases, the electronic commerce transaction involves physical goods.

Often, a consumer may desire to place an item on clearance after a period of time during which the item has not sold at the original asking price. While automatically clearancing inventory is not a new concept, it has never been applied to the consumer-to-consumer auction, classifieds, & consignment market, which has unique characteristics different from retail stores & wholesalers.

### SUMMARY OF THE INVENTION

In one aspect, the present invention is a method of conducting electronic commerce comprising using a computer to perform steps comprising: a) listing an item for sale on a web site at a price; and b) automatically reducing the price of the item at the expiration of a listing time period if the item has not been purchased prior to the expiration of the time period, wherein the item is unique.

In another aspect, the present invention is an electronic commerce system having a computer-readable storage medium having computer-executable code, the computer-executable code comprising: a unique item having a price; an item database for storage of one or more unique items to be listed for sale by a seller for a listing period; a listing period module for monitoring the listing period; and a listing price control module for changing the price of the unique item when the listing period has expired.

The present invention allows an online seller of a unique, one-of-a-kind item to automatically place the item on clearance after a period of time.

### BRIEF DESCRIPTION OF THE DRAWINGS

FIG. 1 illustrates the components of an electronic commerce system that implements an auto-clearance according to one embodiment of the invention.

FIG. 2 illustrates one example of the use of an auto-clearance function.

### DETAILED DESCRIPTION OF SPECIFIC EMBODIMENTS

One specific embodiment of the invention, referred to herein as an “Auto-Clearance service” will now be described with reference to the drawings. This embodiment is intended to illustrate, and not limit, the present invention. The scope of the invention is defined by the claims.

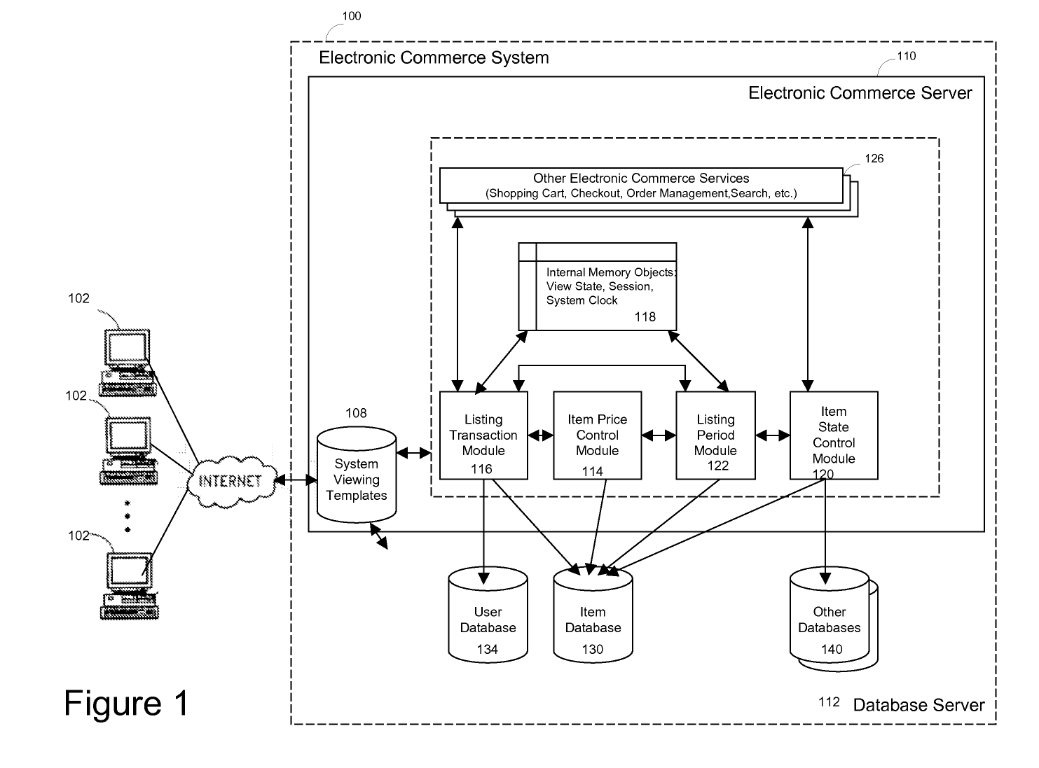

FIG. 1 illustrates the components of an electronic commerce system 100 that implements a an Auto-Clearance service according to one embodiment of the invention. The system 100 includes a electronic commerce server 110, which is represented as a single web server but may be distributed web servers located in the same or different locations, that services requests from user computerized devices 102 (PC's, PDA's, web-enabled phones, web-enabled electronic reading devices and tablets, other mobil devices etc.) over the internet. These devices allow a user to search the electronic commerce system for available items listed for sale The term “sale” is defined herein to mean an exchange of goods for some form of consideration having approximately equal value, including sale for any amount of cash (including zero), swapping, trading, exchanging goods for credit, and other similar transactions. When an item is listed for sale, it is herein referred to as the items' “listing”.

It is critical to note that all components of FIG. 1, 100-140, are shown as individual components, but any of them may be multiple components distributed across multiple physical locations.

The term “seller” as used herein means the consumer involved in the specific transaction being described as the seller of the item. The term “user” as used herein means consumers other than the seller. A seller in this embodiment of the invention is also a “registered member”. A customer can be classified as a “visitor” or as a “registered member”. A “visitor” is defined as being a guest or someone who does not register with the website. Visitors can shop without registering. A “registered member” means the customer provides requested personal information and receives a user name and password to log in to the site, has an account and may be able to track purchases and other historical information.

Referring again to FIG. 1, the Database Server 112, represented herein as a single server but may be multiple distributed servers in the same or different locations, contains an Item Database 130 of information about unique items that are available for purchase. The term “item”, also referred to herein as “unique item” means a unique, one-of-a-kind piece of merchandise. It has specific characteristics and identifier associated with it, and there is or may be only one available. The items represented within the Item Database 130 may include physical products and combinations thereof, such as apparel, books, DVD's, and other consumer products, and/or may include downloadable items and combinations thereof such as software products, music files, and video files. Although depicted as a single-Item Database 130 for purposes of illustration, the item information may be distributed across multiple-distinct databases. The system 100 may support business-to-consumer sales of items, wherein a business includes for-profit and not-for-profit organizations, consumer-to-consumer sales of items, business-to-business sales of items, or any combination of all of these types of sales. Various types of attribute data may be stored in the Item Database 130 for each item, such as, for example, the item's price and availability, images of the item, item traits, detailed description of the item, editorial reviews of the item, user and customer reviews of the item, user and customer questions and seller answers to questions, etc. The change in the attribute associated with the item's availability, is referred to generally as a change in the item's status.

Item availability may be represented as available for purchase or unavailable. Available items are presented to the user when the Item Database 130 is searched via System Viewing Templates 108 that are on the system 100. An Item State Control Module 120 manages an Item's status and availability to users for purchase.

One aspect of the electronic commerce system 100 that controls and monitors an item's availability is a Listing Period Module 122. Once the system receives a request from a seller listing an item via the Listing Transaction Module 116, the date and time the listing is submitted is recorded via the System Clock 118, and parameters may be set in the Listing Period Module 122 that control and monitor the length of time an item's listing is visible to users and available for purchase. Listing periods can be set globally for all items in the Item Database 130 or can be set by any variable contained in the Item Database, such as but not limited to an item's category, type, status, size, condition, price, color, material and/or weight. Listing periods may be specified in minutes, days, weeks, or months. For example, a listing period may be 30 days. In this example, after an item is listed and available for purchase for 30 days, the Listing Period Module 122 can optionally send a trigger to the Item State Control Module 120 to change the item's status to “unavailable for purchase”, which may be represented as “expired”, “ended”, or another status.

The Listing Period Module 122 can also optionally automatically increase the listing period of an item, in which case no trigger is sent to the Item State Control Module 120 to change the status and the item's listing remains in and “available to purchase” status.

The Listing Period Module 122 in this embodiment of the invention also communications a Item Price Control Module 114. Parameters may be set within the Listing Period Module 122 that can automatically trigger the Item Price Control Module 114 to update the price of an item in the Item Database 130 based on the length of time an item has been listed for sale. In this embodiment, the item's price can be automatically decreased such as it can be displayed to the user as “on clearance” or “on sale”, or other similar representation. Prices that are automatically decreased by the system can be displayed in various ways, such that the user may know or not know that the item's price has changed. The seller may rely on default parameters set by the Item Price Control Module 114, or the seller may set their own preferred price decreases. The price can be reduced by a percentage of the original listed price, or the price may be set as a specific reduced price, depending upon the seller's option and the parameters set in the Item Price Control Module 114. For example, the price may be reduced by 15% from the original price, or the price may be reduced $5.00 from the original asking price, The term price is not intended to be limited to U.S. dollars but may be defined in any form currency, including non-monetary currencies such as credits.

Furthermore, several parameters may be set in the Listing Period Module 122 that can trigger multiple decreases to an item's price in the Item Database 130 at various time periods. The seller may rely on default parameters set by the Listing Period Module 122, or the seller may set their own preferred time periods. For example, in one embodiment of the invention, an item's listing can be set to “auto-clearance” after a standard listing period, e.g. 30 days, and decrease in price for example, by 15% each week for 3 consecutive weeks before ultimately expiring and being unavailable for purchase. The price change may be a standard adjustment each time the Listing Period Module 122 triggers a pricing update, or may be a varied adjustment, as determined and set by parameters associated with the Item Price Control Module 114.

The use of an “auto-clearance” function in the electronic commerce system 100 can be mandatory or optional. If optional, the seller of the item can set a default parameter on their user account, residing in a User Database 134, and/or specify a parameter on each individual item's listing via the Listing Transaction Module 116. Additionally, the decision to “auto-clearance” the item's listing may be updated by the Seller while the item's listing is available for purchase. The seller may turn the auto-clearance parameter on or off as desired. Or, parameters may be set in the Listing Period Module 122 that disallow a user to change the auto-clearance after specified time periods, or parameters may be set in the Item Price Control Module 114 that disallow price changes after specified periods of time. The intention of this feature of the invention is to disallow sellers from increasing the price of their item right before they set their item to “auto-clearance”, thereby confusing users of the system and falsely representing an item as being “on sale” or “on clearance”. The seller may also set the specific parameters such as the percentages and the timing of when the parameters will be applied.

Once all parameters for continuing to a list an item are no longer found by the Listing Period Module 122, the module will send a trigger to the Listing Transaction Module 116 to expire an item's listing and make it unavailable for purchase. The item may remain in the Item Database 130 for Sellers to determine if they want to relist an item for sale, save the item in their account, or delete the item from the Item Database 130. When and if a Seller decides to relist an item for sale, the same or different “auto-clearance” parameters may be used for the new listing by the Seller or assigned by the Listing Period Module 122 and Item Price Control Module 114.

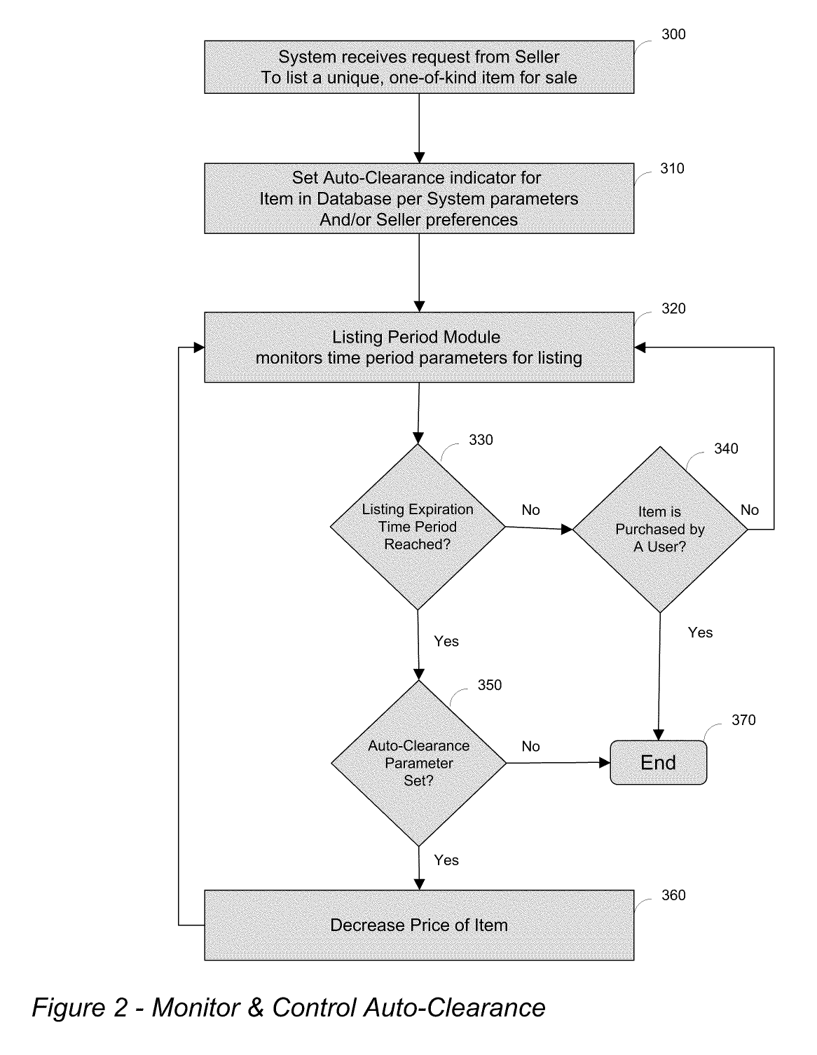

FIG. 2 illustrates how one embodiment of this invention may work in practice. The electronic Commerce System 100 receives a request from a Seller to list an item for sale 300 and, per system parameters or seller preferences, assigns an Auto-Clearance indicator to the item 310. The item's listing is then continuously monitored by the Listing Period Module 122 via the System Clock 118. After specified parameters are reached, the Listing Period Module 122 and the Item Price Control Module 114 work together to determine if and when a listing should expire, whether a listing should be extended if auto-clearance parameters are set 350, and when and if a listing's price should be decreased 360.

What is claimed is:

1. A method of conducting electronic commerce comprising:
using a computer to perform steps comprising:
a) listing an item for sale on a web site at a price; and
b) automatically reducing the price of the item at the expiration of a listing time period if the item has not been purchased prior to the expiration of the time period,
wherein the item is unique.

2. The method of claim 1, wherein in step b), the price is reduced by a pre-determined percentage.

3. The method of claim 1, wherein in step b), the price is reduced by a pre-determined dollar amount.

4. The method of claim 1, further comprising the step of:
c) automatically reducing the price of the item a second time at the expiration of a second time period if the item has not been purchased prior to the expiration of the second time period.
The method of claim 4 wherein step (c) is repeated one or more times.

5. The method of claim 3, wherein the time period in step b) and the second time period in step (c) are the same.

6. The method of claim 3, wherein the time period in step b) and the second time period in step c) are different.

7. The method of claim 3, wherein in step c) the price is reduced by the same percentage as in step b).

8. The method of claim 3, wherein in step c) the price is reduced by a different percentage than in step b).

9. An electronic commerce system having a computer-readable storage medium having computer-executable code, the computer-executable code comprising:
a unique item having a price;
an item database for storage of one or more unique items to be listed for sale by a seller for a listing period;
a listing period module for monitoring the listing period; and
a listing price control module for changing the price of the unique item when the listing period has expired.
